(19) United States
(12) Patent Application Publication
(10) Pub. No.: US 2025/0388033 A1
(43) Pub. Date: Dec. 25, 2025

(54) MEDIUM CONVEYANCE DEVICE AND RECORDING APPARATUS

(71) Applicant: SEIKO EPSON CORPORATION, Tokyo (JP)

(72) Inventors: Yuto SUZUKI, SHIOJIRI-SHI (JP); Yutaro HARADA, SHIOJIRI-SHI (JP); Hirohisa KODAIRA, MATSUMOTO-SHI (JP); Hiroyuki KOSUGE, MATSUMOTO-SHI (JP); Toshikazu KOTAKA, MATSUMOTO-SHI (JP); Masaaki NISHIZAWA, NAGANO-SHI (JP); Kenichi SHIMO, SHIOJIRI-SHI (JP); Hiroyuki MAEDA, MATSUMOTO-SHI (JP)

(21) Appl. No.: 19/245,506

(22) Filed: Jun. 23, 2025

(30) Foreign Application Priority Data
Jun. 24, 2024 (JP) 2024-101425

(51) Int. Cl. B41J 13/03; B41J 11/00; B41J 13/00; B41J 13/076

(52) U.S. Cl. CPC B41J 13/03; B41J 11/006; B41J 13/0027; B41J 13/076

(57) ABSTRACT

A medium conveyance device includes first rotating bodies, second rotating bodies, a first drive section, a second drive section, and an operation section coupled to the first drive section and the second drive section. The first and the second rotating bodies are able to be manually operated with the operation section. The operation section includes an input section to which an operation force can be manually input and a switching section capable of switching a transmission state and a disconnected state. The switching section includes a first and second switching sections coupled to, respectfully, first and second drive sections. The switching section takes the disconnected state when a driving force is input from the first or second drive source and takes the transmission state when the driving force is not input from the first or the second drive source and an operation force is input to the input section.

The present application is based on, and claims priority from JP Application Serial Number 2024-101425,filed Jun. 24, 2024, the disclosure of which is hereby incorporated by reference herein in its entirety.

### BACKGROUND

### 1. Technical Field

The present disclosure relates to a medium conveyance device and a recording apparatus.

### 2. Related Art

Various medium conveyance devices that convey media have been used. Among these medium conveyance devices, there is a medium conveyance device including, as a medium conveyance section, a plurality of rotating bodies that convey a medium by rotating in contact with the medium. For example, JP-A-2024-31520 discloses an inkjet printer including a plurality of conveyance roller pairs that convey a medium by rotating in contact with the medium.

JP-A-2024-31520 is an example of the related art.

In the medium conveyance device including the plurality of rotating bodies that convey a medium by rotating in contact with the medium, the medium sometimes stops in a conveyance path because of a jam or the like. Therefore, JP-A-2024-31520 discloses that, in order to remove the jammed medium, the rotating bodies are rotated by manually rotating a driving roller with an operation unit, that is, by rotating a handle.

On the other hand, in order to diversify medium conveyance control, it is conceivable to adopt a configuration for differentiating a drive source for each of the rotating bodies. In the case of such a configuration, it is necessary to synchronize the rotating bodies in order to remove the jammed medium that has stopped across the rotating bodies of the different drive sources. For example, this is because, when the medium is temporarily moved to the downstream side in a conveyance direction in order to remove the jammed medium, it is difficult to convey the medium to the downstream side because, even if only the rotating body on the downstream side is rotated, the rotating body on the upstream side does not rotate and it is difficult to convey the medium to the downstream side because, even if only the rotating body on the upstream side is rotated, only the medium is bent and the rotating body on the downstream side does not rotate. In the medium conveyance device of the related art, the medium stopped across the rotating bodies of the different drive sources cannot be easily removed.

### SUMMARY

In order to solve the above problem, according to an aspect of the present disclosure, there is provided a medium conveyance device including: a first rotating body configured to convey a medium in a conveyance direction by rotating in contact with the medium; a second rotating body configured to, downstream of the first rotating body in the conveyance direction, convey the medium in the conveyance direction by rotating in contact with the medium conveyed by the first rotating body; a first drive section configured to drive the first rotating body with a driving force of a first drive source; a second drive section configured to drive the second rotating body with a driving force of a second drive source; and an operation section coupled to the first drive section and the second drive section, the first rotating body and the second rotating body being able to be manually operated with the operation section, wherein the operation section includes: an input section to which an operation force can be manually input; a switching section configured to switch a transmission state in which drive is transmitted between the input section and the first and the second drive sections and a disconnected state in which the drive is not transmitted between the input section and the first and the second drive sections, the switching section includes a first switching section coupled to the first drive section and a second switching section coupled to the second drive section, and the switching section takes the disconnected state when the driving force is input from the first drive source or the second drive source and takes the transmission state when the driving force is not input from the first drive source or the second drive source and an operation force is input to the input section.

### BRIEF DESCRIPTION OF THE DRAWINGS

FIG. 1 is an internal configuration diagram of a recording apparatus including a medium conveyance device according to a first embodiment of the present disclosure viewed from the front side.

FIG. 2 is a rear view of a protrusion unit of the recording apparatus illustrated in FIG. 1.

FIG. 3 is a perspective view of an operation section of the recording apparatus of FIG. 1.

FIG. 4 is a perspective view illustrating a periphery of a part of a switching section of the operation section of the recording apparatus illustrated in FIG. 1.

FIG. 5 is a perspective view illustrating the periphery of an input section of the operation section of the recording apparatus illustrated in FIG. 1.

FIG. 6 is a perspective view illustrating the periphery of a part of the switching section of the recording apparatus illustrated in FIG. 1, the part of the switching section being a portion different from the portion illustrated in FIG. 4.

FIG. 7 is a schematic diagram of a wheel train of the recording apparatus illustrated in FIG. 1 viewed from the front side and is a diagram illustrating rotation states of gears of the wheel train at the time when a first drive source and a second drive source are driven.

FIG. 8 is a schematic diagram of the wheel train of the recording apparatus illustrated in FIG. 1 viewed from the front side and is a diagram illustrating the rotation states of the gears of the wheel train at the time when the input section is rotated counterclockwise.

FIG. 9 is a schematic diagram of the wheel train of the recording apparatus illustrated in FIG. 1 viewed from the front side and is a diagram illustrating the rotation states of the gears of the wheel train at the time when the input section is rotated clockwise.

### DESCRIPTION OF EMBODIMENTS

The present disclosure is schematically explained below.

According to a first aspect of the present disclosure, there is provided a medium conveyance device including: a first rotating body configured to convey a medium in a conveyance direction by rotating in contact with the medium; a second rotating body configured to, downstream of the first rotating body in the conveyance direction, convey the medium in the conveyance direction by rotating in contact with the medium conveyed by the first rotating body; a first drive section configured to drive the first rotating body with a driving force of a first drive source; a second drive section configured to drive the second rotating body with a driving force of a second drive source; and an operation section coupled to the first drive section and the second drive section, the first rotating body and the second rotating body being able to be manually operated with the operation section, wherein the operation section includes: an input section to which an operation force can be manually input; and a switching section configured to switch a transmission state in which drive is transmitted between the input section and the first and the second drive sections and a disconnected state in which the drive is not transmitted between the input section and the first and the second drive sections, the switching section includes a first switching section coupled to the first drive section and a second switching section coupled to the second drive section, and the switching section takes the disconnected state when the driving force is input from the first drive source or the second drive source and takes the transmission state when the driving force is not input from the first drive source or the second drive source and an operation force is input to the input section.

According to this aspect, in a configuration in which a plurality of rotating bodies, that is, the first rotating body and the second rotating body are driven by different drive sources, that is, the first drive section and the second drive section, the operation section coupled to both the drive sections is provided. Accordingly, it is possible to rotate both of the rotating bodies, that is, the first rotating body and the second rotating body, in association with each other by inputting the operation force to one operation section. On the other hand, when at least one drive source of the first drive section and the second drive section is driven, it is possible to prevent a load involved in the coupling of the operation section to the drive section from occurring because the switching section takes the disconnected state. Further, for example, when there is a rotating body other than the first rotating body and the second rotating body, it is possible to prevent the rotating body from being affected by the load involved in the coupling of the operation section to the drive section. That is, it is possible to easily remove the medium stopped across the rotating bodies of the different drive sources.

According to a second aspect of the present disclosure, in the medium conveyance device according to the first aspect, the first rotating body and the second rotating body may convey the medium downstream in the conveyance direction by rotating in a first rotation direction and may be configured to be rotatable only in the first rotation direction when the operation force is input to the input section.

According to this aspect, the first rotating body and the second rotating body convey the medium downstream in the conveyance direction by rotating in the first rotation direction and are configured to be rotatable only in the first rotation direction when the operation force is input to the input section. As explained above, by limiting a moving direction of the medium at the time when the operation force is input to the input section, it is possible to prevent the medium from moving in an unintended direction.

According to a third aspect of the present disclosure, in the medium conveyance device according to the second aspect, the first switching section and the second switching section may respectively include one-way clutches.

According to this aspect, the first switching section and the second switching section respectively include the one-way clutches. With the configuration explained above, it is possible to implement a simple configuration.

According to a fourth aspect of the present disclosure, in the medium conveyance device according to any one of the first to third aspects, the first switching section and the second switching section may be provided coaxially with the input section.

According to this aspect, the first switching section and the second switching section are provided coaxially with the input section. With the configuration explained above, it is possible to reduce a space occupied by the first switching section and the second switching section and the like on the inside of the medium conveyance device.

According to a fifth aspect of the present disclosure, in the medium conveyance device according to the fourth aspect, the operation section may include a shaft section configured to rotate integrally with the input section, the first switching section may include: a first gear coupled to the first drive section and configured to rotate centering on the shaft section; and a one-way clutch configured to switch the transmission state and the disconnected state between the shaft section and the first gear, and the second switching section may include: a second gear coupled to the second drive section and configured to rotate centering on the shaft section; and a one-way clutch configured to switch the transmission state and the disconnected state between the shaft section and the second gear.

According to this aspect, the operation section includes the shaft section configured to rotate integrally with the input section, the first switching section includes the first gear coupled to the first drive section and configured to rotate centering on the shaft section and the one-way clutch configured to switch the transmission state and the disconnected state between the shaft section and the first gear and the second switching section includes the second gear coupled to the second drive section and configured to rotate centering on the shaft section and the one-way clutch configured to switch the transmission state and the disconnected state between the shaft section and the second gear. With the configuration explained above, it is possible to reduce the space occupied by the first switching section and the second switching section and the like on the inside of the medium conveyance device and it is possible to implement a simple configuration of these sections.

According to a sixth aspect of the present disclosure, in the medium conveyance device according to any one of the first to fifth aspects, a gear ratio of the first gear and the first rotating body may be equal to a gear ratio of the second gear and the second rotating body.

According to this aspect, the gear ratio of the first gear and the first rotating body is equal to the gear ratio of the second gear and the second rotating body. With the configuration explained above, by making the gear ratios uniform and rotating the first gear and the second gear at uniform speed, it is possible to prevent bending from occurring in the medium and prevent rubbing from occurring between the medium and the rotating body.

According to a seventh aspect of the present disclosure, in the medium conveyance device according to any one of the first to sixth aspects, the first rotating body and the second rotating body may rotate at same speed when the switching section is in the transmission state.

According to this aspect, the first rotating body and the second rotating body rotate at the same speed when the switching section is in the transmission state. With the configuration explained above, by rotating the first gear and the second gear at the uniform speed, it is possible to prevent bending from occurring in the medium and prevent rubbing from occurring between the medium and the rotating body.

According to an eighth aspect of the present disclosure, in the medium conveyance device according to any one of the first to seventh aspects, the medium conveyance device may further include a housing capable of housing the first rotating body, the second rotating body, the first drive section, the second drive section, and the operation section, and the second rotating body may be a discharge roller configured to discharge the medium from the housing.

According to this aspect, the medium conveyance device further includes the housing capable of housing the first rotating body, the second rotating body, the first drive section, the second drive section, and the operation section, and the second rotating body is the discharge roller configured to discharge the medium from the housing. With the configuration explained above, by driving the discharge roller separately from the first rotating body, it is possible to achieve both of improvement in productivity and improvement in alignment of the discharged medium.

According to a ninth aspect of the present disclosure, in the medium conveyance device according to any one of the first to eighth aspects, the medium conveyance device may further include: the housing capable of housing the first rotating body, the second rotating body, the first drive section, the second drive section, and the operation section; and a displacement section capable of displacing to a housed state in which the first rotating body, the second rotating body, the first drive section, the second drive section, and the operation section are housed in the housing and a protruding state in which the first rotating body, the second rotating body, the first drive section, the second drive section, and the operation section protrude from the housing, and the input section may be exposed from the housing in the protruding state.

According to this aspect, the medium conveyance device further includes the housing capable of housing the first rotating body, the second rotating body, the first drive section, the second drive section, and the operation section, and the displacement section capable of displacing to the housed state in which the first rotating body, the second rotating body, the first drive section, the second drive section, and the operation section are housed in the housing and the protruding state in which the first rotating body, the second rotating body, the first drive section, the second drive section, and the operation section protrude from the housing, and the input section is exposed from the housing in the protruding state. With the configuration explained above, it is possible to expose the operation section in a protruding state in which the operation section protrudes from the housing and it is possible to facilitate, for example, removal of a jammed medium.

According to a tenth aspect of the present disclosure, in the medium conveyance device according to any one of the first to ninth aspects, the medium conveyance device may further include: a control section configured to control the second drive source; and a receiving section configured to receive designation of the driving force of the second drive source.

According to this aspect, the medium conveyance device further includes the control section configured to control the second drive source and the receiving section configured to receive the designation of the driving force of the second drive source. With the configuration explained above, it is possible to designate the driving force of the second drive source, that is, the speed of the second rotating body and it is possible to improve usability.

According to an eleventh aspect of the present disclosure, in the medium conveyance device according to the tenth aspect, the receiving section may be capable of receiving an instruction to reset designation of the driving force of the second drive source.

According to this aspect, the receiving section is capable of receiving the instruction to reset the designation of the driving force of the second drive source. With the configuration explained above, it is possible to reset the driving force of the second drive source, that is, the speed of the second rotating body and it is possible to improve usability.

A recording apparatus according to a twelfth aspect of the present disclosure includes: the medium conveyance device according to any one of the first to eleventh aspects; and a recording section configured to perform recording on the medium conveyed by the medium conveyance device, wherein the medium conveyance device includes: a feeding path configured to feed the medium to the recording section; a reversing path configured to reverse a front and a back of the medium on which the recording was performed by the recording section and cause the medium to merge with the feeding path; and a first discharge path configured to discharge the medium on which the recording was performed by the recording section, the first drive source drives a reversing path rotating body located in the reversing path, and the second rotating body is located in the first discharge path.

According to this aspect, the recording apparatus further includes the recording section that performs the recording on the medium conveyed by the medium conveyance device. For this reason, it is possible to perform recording on the medium conveyed by the medium conveyance device that can easily remove the medium stopped over the rotating bodies of the different drive sources.

According to a thirteenth aspect of the present disclosure, in the recording apparatus according to the twelfth aspect, the first discharge path may be a discharge path configured to discharge, without curving, the medium on which the recording was performed by the recording section, the medium conveyance device may further include a second discharge path configured to branch from the first discharge path and curve and discharge the medium on which the recording was performed by the recording section, the first rotating body and the second rotating body may be located in the first discharge path, and the first drive source may drive a second discharge path rotating body located in the second discharge path.

According to this aspect, the medium conveyance device includes the second discharge path in addition to the first discharge path. It is possible to easily remove the medium stopped across the rotating bodies of the different drive sources not only in the first discharge path but also in the second discharge path.

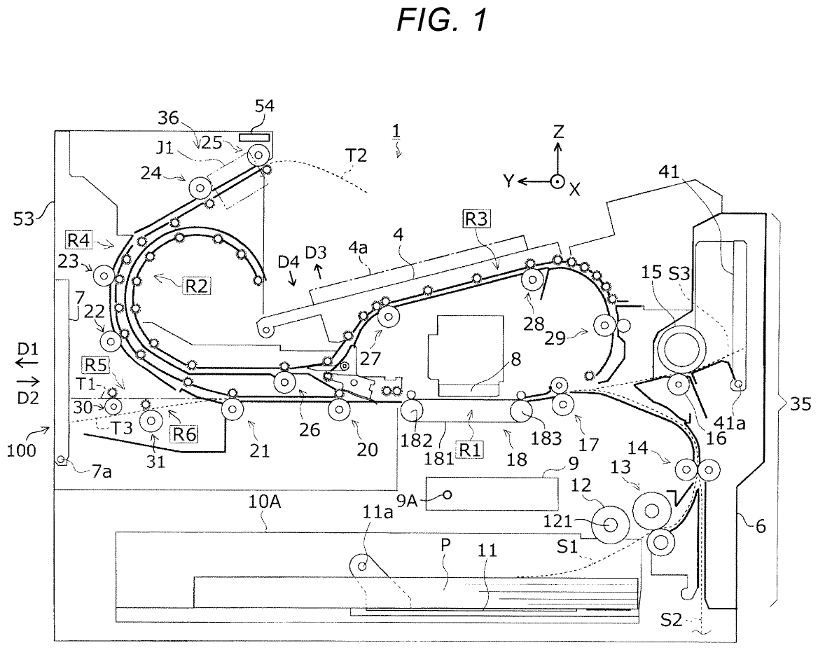

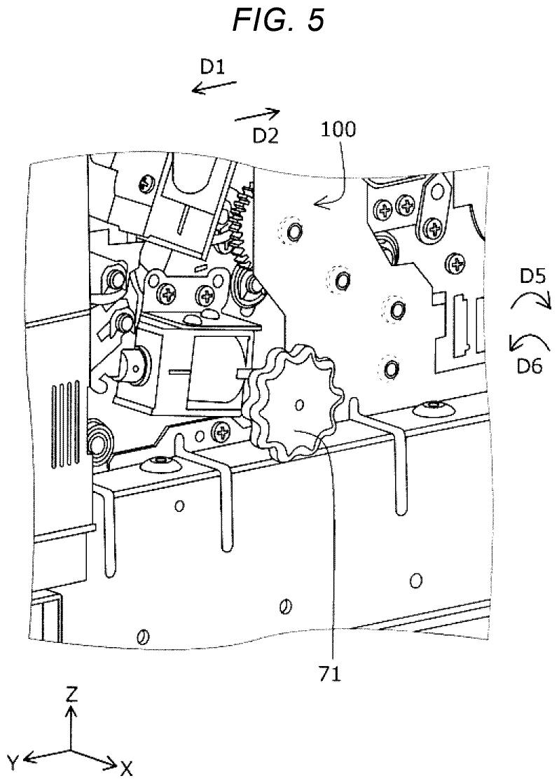

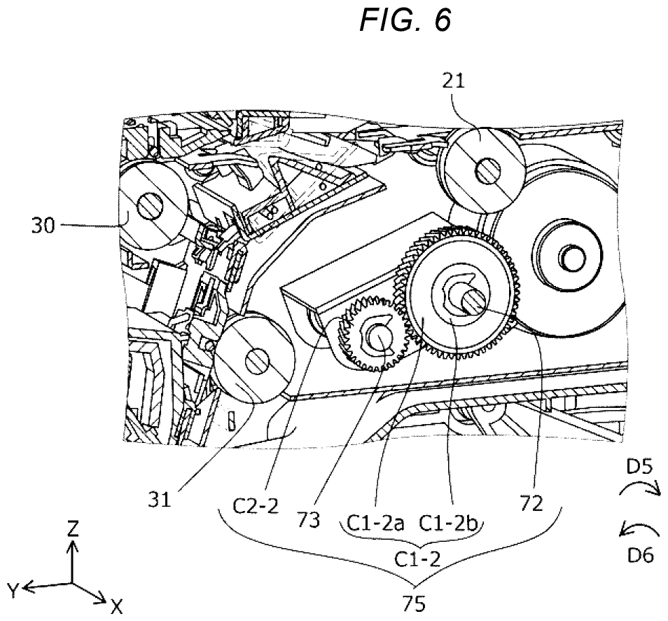

Hereinafter, a recording apparatus 1 including a medium conveyance device according to an embodiment of the present disclosure is explained with reference to FIGS. 1 to 9. In an X-Y-Z coordinate system illustrated in the figures, an X-axis direction indicates the front and back directions of the apparatus and the medium width direction, a Y-axis direction indicates the side surface direction of the apparatus, and a Z-axis direction indicates the height direction and the direction of gravity of the apparatus. A direction in which a medium P is conveyed is referred to as “downstream” and a direction opposite to the direction is referred to as “upstream”. In addition, in the figures, some constituent members are sometimes omitted or simplified in order to facilitate understanding of an internal configuration and the like.

First, an overview of the recording apparatus 1 in the present embodiment is explained with reference to FIG. 1. As illustrated in FIG. 1, the recording apparatus 1 in the present embodiment includes a housing 53 and includes a discharge tray 4 that receives the medium P discharged with an image being recorded thereon. In the discharge tray 4, a rib 4a movable in a rising direction D3 and a falling direction D4 is provided. Basically, the rib 4a is located in the rising direction D3 when a small number of media P are stacked on the discharge tray 4 or a recording duty of the medium P on which the recording has been performed is high and is located in the falling direction D4 when a large number of media P are stacked on the discharge tray 4 or the recording duty of the medium P on which the recording has been performed is low. As explained above, the rib 4a is capable of automatically moved in the rising direction D3 and the falling direction D4 according to the size or the number of media P stacked on the discharge tray 4. However, it is also possible to make it selectable to locate the rib 4a in the rising direction D3 or locate the rib 4a in the falling direction D4 in response to an instruction received from a user via a not-illustrated external computer or the like.

The recording apparatus 1 includes an opening and closing cover 6, and the opening and closing cover 6 is configured to be able to turn centering on a not-illustrated turning shaft and is capable of opening and closing by turning centering on the turning shaft. In the opening and closing cover 6, a manual feed tray 41 is provided. The manual feed tray 41 swings centering on a swing shaft 41a and can be opened and closed with respect to the opening and closing cover 6.

The recording apparatus 1 includes three medium feeding paths including a feeding path from a medium cassette 10A corresponding to a cassette feeding track S1, a feeding path from a not-illustrated additional cassette corresponding to an additional cassette feeding track S2, and a feeding path from the manual feed tray 41, on which the medium P is placed, corresponding to a manual feeding path S3. The recording apparatus 1 has three medium discharge methods including face-up discharge corresponding to a face-up discharge track Tl and for discharging the medium P with a first surface, on which the recording has been most recently performed, facing up, face-down discharge corresponding to a face-down discharge track T2 and for discharging the medium P with the first surface facing down, and discharge corresponding to a finisher discharge track T3, the discharge being discharge to a post-processing device in the case in which the post-processing device or the like that performs post-processing on the medium P is coupled downstream of the recording apparatus 1.

The recording apparatus 1 includes a face-up paper discharge tray 7 that receives the medium P to be discharged face-up. The face-up paper discharge tray 7 can take a stored state illustrated in FIG. 1 and a not-illustrated open state by turning centering on a turning shaft 7a. The recording apparatus 1 includes six medium conveyance paths including a recording conveyance path R1, a switchback path R2, a reversing path R3, a face-down discharge path R4, a face-up discharge path R5, and a finisher discharge path R6.

The most downstream part of the face-down discharge path R4 is configured by a discharge mechanism section 36. In a region J1 illustrated in FIG. 1, spurs, which are a plurality of driven rollers that rotate following the medium P, are provided. In the discharge mechanism section 36, a fan 54 capable of blowing air to the medium P is provided. Basically, the fan 54 stops blowing air when a recording duty of the medium P on which the recording has been performed (an amount of ink ejected onto the medium P according to the recording) is low and blows air when the recording duty of the medium P on which the recording has been performed is high. As explained above, the fan 54 is capable of automatically switching the blowing and the blowing stop according to the recording duty of the medium P on which the recording has been performed. However, it is also possible to make it selectable to cause the fan 54 to blow air and stop the blowing in response to an instruction received from the user via the not-illustrated external computer or the like.

Further, the discharge mechanism section 36 can automatically change, according to the recording duty of the medium P on which the recording has been performed, in a plurality of stages, discharge speed of the medium P immediately before being discharged to the discharge tray 4. Basically, the discharge speed of the medium P immediately before being discharged to the discharge tray 4 is set lower as the recording duty of the medium P on which the recording has been performed is higher. However, it is also possible to make the discharge speed of the medium P selectable in response to an instruction from the user received via the not-illustrated external computer or the like. Furthermore, in order to secure a drying time, the discharge mechanism section 36 can also temporarily stop, according to the recording duty of the medium P on which the recording has been performed, the conveyance of the medium P immediately before being discharged to the discharge tray 4. It is also possible to discharge the medium P to the discharge tray 4 by increasing the speed of the medium P with a discharge roller pair 25 to prevent the medium P from accumulating in a downstream region or the like of the medium conveyance path.

The same discharge processing as the discharge processing explained above can be performed in the face-up discharge path R5 as well. That is, the discharge mechanism section 36 can automatically change, according to the recording duty of the medium P on which the recording has been performed, in a plurality of stages, the discharge speed of the medium P immediately before being discharged to the face-up paper discharge tray 7. Basically, the discharge speed of the medium P immediately before being discharged to the face-up paper discharge tray 7 is set lower as the recording duty of the medium P on which the recording has been performed is higher. However, it is also possible to make the discharge speed of the medium P selectable in response to an instruction from the user received via the not-illustrated external computer or the like. Furthermore, the discharge mechanism section 36 is capable of temporarily stopping, according to the recording duty of the medium P on which the recording has been performed, the conveyance of the medium P immediately before being discharged to the face-up paper discharge tray 7.

A control section 9 that performs various kinds of control acquires recording data, which is data for performing recording, generated by a printer driver operating on the not-illustrated external computer or a printer driver provided in the control section 9. The control section 9 controls, based on the recording data, an inkjet type recording head 8, various medium conveyance rollers driven by a not-illustrated motor, flaps, which are path switching members, and the like. The control section 9 performs necessary control based on detection states of various sensors such as a sensor that detects passage of the medium P. In FIG. 1, the control section 9 is conceptually illustrated and is actually configured by a circuit board provided at a predetermined position in an apparatus main body 35.

Here, a medium feeding path to a registration roller pair 17 is explained. The medium cassette 10A detachably provided in the apparatus main body 35 includes a hopper 11. The hopper 11 swings centering on a shaft 11a, whereby the medium P stored in the medium cassette 10A comes into contact with and separates from a feeding roller 12 driven to rotate by a not-illustrated motor.

The medium P delivered from the medium cassette 10A by the feeding roller 12 receives a feeding force from a conveyance roller pair 14 and reaches the registration roller pair 17 in a state in which the medium P is separated by passing through a nip position formed by a separation roller pair 13 and multi-feed is prevented. Similarly, not-illustrated additional cassettes located below the apparatus main body 35 include feeding rollers 12 and separation roller pairs 13. The medium P delivered from the additional cassettes receives the feeding force from the conveyance roller pair 14 illustrated in FIG. 1 and reaches the registration roller pair 17. A feeding roller 15 and a separation roller 16 are provided in the manual feeding path S3, which is a medium feeding path from the manual feed tray 41. The medium P set on the manual feed tray 41 reaches the registration roller pair 17 according to rotation of these rollers.

In the medium conveyance path, the registration roller pair 17, conveyance roller pairs 20-24, conveyance roller pairs 26-31, and the discharge roller pair 25 serving as a discharge section that discharges the medium P are provided. The roller pairs include driving rollers driven by a not-illustrated motor and driven rollers capable of nipping the medium P between the driven rollers and the driving rollers and driven to rotate in contact with the medium P. The recording conveyance path R1 serving as a first conveyance path passes below the recording head 8 serving as a recording section, which performs recording on the medium P, and extends to the upstream side and the downstream side of the recording head 8. In the recording conveyance path R1, the medium P receives a feeding force from the registration roller pair 17 and a belt unit 18. The belt unit 18 includes an electrostatic attraction belt 181 that conveys the medium P and a driving roller 182 and a driven roller 183 on which the electrostatic attraction belt 181 is wound.

The recording head 8 in the present embodiment is a so-called line head in which nozzles for ejecting ink are provided to cover an entire medium width direction region and is configured as a recording head capable of performing recording on the entire medium width without involving movement in the medium width direction. However, when the recording head 8 is a recording section that performs recording by ejecting a liquid such as ink onto the medium P, the recording head 8 is not limited to the line head. Furthermore, the recording apparatus 1 may include a recording section that performs recording using toner instead of the recording section that ejects the liquid ink.

The switchback path R2 serving as a second conveyance path is a medium conveyance path coupled to the recording conveyance path R1 and is a path for feeding, in the left direction in FIG. 1, the medium P passing below the recording head 8 and thereafter switching back the medium P to convey the medium P in the right direction in FIG. 1, which is a direction opposite to the feeding direction, and is located on the inner side of a curve with respect to the face-down discharge path R4 explained later. In the switchback path R2, the medium P receives a feeding force from the conveyance roller pair 26.

The reversing path R3 serving as a third conveyance path is a medium conveyance path coupled to the switchback path R2 and causes the medium P conveyed in the opposite direction, which is the right direction in FIG. 1, to bypass the upper side of the recording head 8 and to be inverted and, in the present embodiment, causes the medium P to merge at an upstream side position of the recording head 8 in the recording conveyance path R1, which is an upstream position of the registration roller pair 17. In the reversing path R3, the medium P receives a feeding force from the conveyance roller pairs 27, 28, and 29.

The face-down discharge path R4 serving as a fourth conveyance path is a medium conveyance path coupled to the recording conveyance path R1 and is a path for curving the medium P, which has passed below the recording head 8, with the surface facing the recording head 8 set on the inner side, reversing the medium P, and discharging the medium P. In the face-down discharge path R4, the medium P receives a feeding force from the conveyance roller pairs 20, 21, 22, 23, and 24 and the discharge roller pair 25. The most downstream part of the face-down discharge path R4 is configured by the discharge mechanism section 36 as explained above. Flaps serving as path switching members that switch the medium conveyance paths are provided at connecting sections of the medium conveyance paths. The flaps set a path on which the medium P travels.

As explained above, the face-up discharge path R5 serving as a fifth conveyance path is a path for discharging the medium P, which has passed below the recording head 8, to the face-up paper discharge tray 7 such that the surface facing the recording head 8 faces upward. The conveyance roller pair 30 is provided in the face-up discharge path R5. As explained above, the finisher discharge path R6 as a sixth conveyance path is a discharge path to a post-processing device in the case in which the post-processing device or the like that performs post-processing on the medium P is coupled downstream of the recording apparatus 1. In the finisher discharge path R6, the conveyance roller pair 31 is provided.

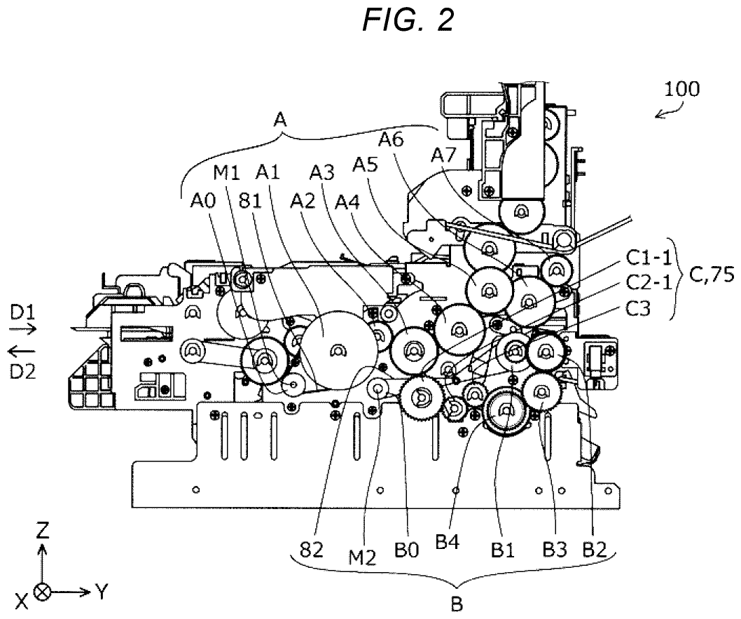

The recording apparatus 1 according to the present embodiment is configured be capable of protruding a protrusion unit 100 including a plurality of internal constituent members by moving the protrusion unit 100 in a protrusion direction D1 from the housing 53. The protrusion unit 100 corresponds to a region on the left side in FIG. 1 including the face-down discharge path R4 including the conveyance roller pairs 20, 21, 22, and 23, the face-up discharge path R5 including the face-up paper discharge tray 7 and the conveyance roller pair 30, and the finisher discharge path R6 including the conveyance roller pair 31. By moving the protrusion unit 100 in the protrusion direction D1 with respect to the housing 53 and protruding the protrusion unit 100, it is easy to take out the medium P, for example, when a jam occurs in the medium P in the medium conveyance path. By inserting the protrusion unit 100 into the housing 53 in an insertion direction D2, it is possible to easily return the protrusion unit 100 to the state illustrated in FIG. 1. Hereinafter, details of the protrusion unit 100 are explained with reference to FIGS. 2 to 6.

FIG. 2 illustrates an entire configuration of the protrusion unit 100 viewed from the back direction. The protrusion unit 100 includes wheel trains, rotating shafts of all of which includes motors and gears corresponding to the X-axis direction. Specifically, the protrusion unit 100 includes a motor M1 serving as a first drive source, a gear A0 attached to a rotating shaft of the motor M1, and a belt 81 attached to the gear A0. Furthermore, the protrusion unit 100 includes a gear A1 to which the belt 81 is attached, a gear A2 that meshes with the gear A1, a gear A3 that meshes with the gear A2, a gear A4 that meshes with the gear A3, a gear A5 that meshes with the gear A4, a gear A6 that meshes with the gear A5, and a gear A7 that meshes with the gear A6. That is, the gear A1, the gear A2, the gear A3, the gear A4, the gear A5, the gear A6, and the gear A7 are configured to be rotatable by a driving force of the motor M1 and configure a first wheel train A. Here, a rotating shaft of the gear Al is a rotating shaft of a driving roller of the conveyance roller pair 20, a rotating shaft of the gear A3 is a rotating shaft of a driving roller of the conveyance roller pair 21, and a rotating shaft of the gear A7 is a rotating shaft of a driving roller of the conveyance roller pair 22.

The protrusion unit 100 includes a motor M2 serving as a second drive source, a gear B0 attached to a rotating shaft of the motor M2, and a belt 82 attached to the gear B0. Furthermore, the protrusion unit 100 includes a gear B1 to which the belt 82 is attached, a gear B2 that meshes with the gear B1, a gear B3 that meshes with the gear B2, and a gear B4 that meshes with the gear B3. That is, the gear B1, the gear B2, the gear B3, and the gear B4 are configured to be rotatable by a driving force of the motor M2 and configure a second wheel train B. Here, a rotating shaft of the gear B2 is a rotating shaft of a driving roller of the conveyance roller pair 30 and a rotating shaft of the gear B4 is a rotating shaft of a driving roller of the conveyance roller pair 31.

Since the first wheel train A and the second wheel train B have different drive sources, the control section 9 can perform different drive controls for the first wheel train A and the second wheel train B. For example, the control section 9 can increase conveyance speed by rotating the conveyance roller pairs 20, 21, and 23 corresponding to the first wheel train A fast in order to improve productivity and can reduce the conveyance speed by rotating the conveyance roller pairs 30 and 31 corresponding to the second wheel train B slowly in order to prevent the medium P from jumping out when being discharged. According to a type or the like of the medium P, it is possible to finely adjust the conveyance roller pairs 20, 21, and 23 corresponding to the first wheel train A and the conveyance roller pairs 30 and 31 corresponding to the second wheel train B such that the conveyance roller pairs rotate at suitable rotation speeds.

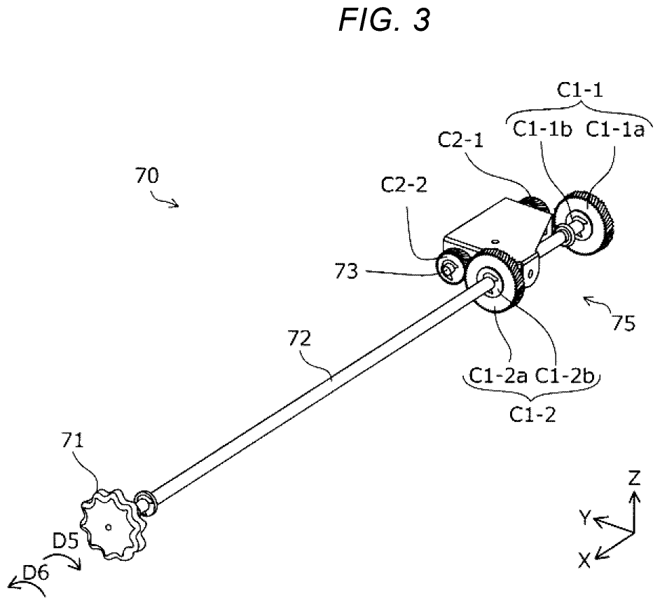

Further, the protrusion unit 100 includes an operation section 70 illustrated in FIG. 3 and the like. The operation section 70 is exposed from the housing 53 when the protrusion unit 100 moves in the protrusion direction D1 with respect to the housing 53. By moving the protrusion unit 100 in the protrusion direction D1 with respect to the housing 53 and manually operating the operation section 70, the user can rotate first rotating bodies such as the conveyance roller pairs 20, 21, and 22 and second rotating bodies such as the conveyance roller pairs 30 and 31. That is, for example, when a jam occurs in the medium P in the medium conveyance path, the user can manually move the medium P to the downstream side in the conveyance direction and can take out the medium P at a desired position where the medium P can be easily taken out.

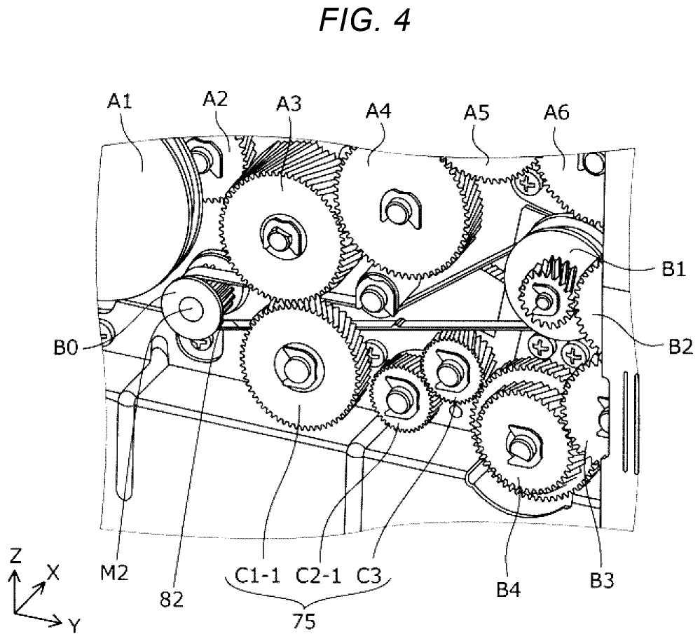

As illustrated in FIGS. 3 to 6, the operation section 70 includes an input section 71 that the user can manually rotate in rotation directions D5 and D6, that is, to which the user can manually input an operation force, a shaft section 72 that rotates according to the rotation of the input section 71, gears C 1-1 and C 1-2 both coupled to the shaft section 72, a gear C 2-1 provided near the gear C 1-1 without meshing with the gear C 1-1, and a gear C 2-2 that meshes with the gear C 1-2. Further, as illustrated in FIGS. 2 and 4 and the like, the operation section 70 includes a gear C3 that meshes with the gear B4 and meshes with the gear C 2-1. The gear C 1-1, the gear C 1-2, the gear C 2-1, the gear C 2-2, and the gear C3 configure a third wheel train C and a switching section 75 explained below.

Here, the gear C 2-1 and the gear C 2-2 rotate together because of having a common shaft section 73. The switching section 75 includes a one-way clutch. In the present embodiment, the gear C 1-1 has a function of a one-way clutch and includes an outer section C 1-1a that meshes with the gear A3 and an inner section C 1-1b coupled to the shaft section 72. When the outer section C 1-1a rotates in the rotation direction D5, the inner section C 1-1b also rotates together. However, when the outer section C 1-1a rotates in the rotation direction D6, the inner section C 1-1b does not rotate together and the outer section C 1-1a idles. When the inner section C 1-1b rotates in the rotation direction D6, the outer section C 1-1a also rotates together. However, when the inner section C 1-1b rotates in the rotation direction D5, the outer section C 1-1a does not rotate together and the inner section C 1-1b idles.

Similarly, the gear C 1-2 also has a function of a one-way clutch and includes an outer section C 1-2a and an inner section C 1-2b coupled to the shaft section 72. When the outer section C 1-2a rotates in the rotation direction D5, the inner section C 1-2b also rotates together. However, when the outer section C 1-2a rotates in the rotation direction D6, the inner section C 1-2b does not rotate together and the outer section C 1-2a idles. When the inner section C 1-2b rotates in the rotation direction D6, the outer section C 1-2a also rotates together. However, when the inner section C 1-2b rotates in the rotation direction D5, the outer section C 1-2a does not rotate together and the inner section C 1-2b idles.

As explained above, the recording apparatus 1 in the present embodiment serving as the medium conveyance device can be expressed as including the first rotating bodies such as the conveyance roller pairs 20, 21, and 22 that convey the medium P in the conveyance direction by rotating in contact with the medium P and the second rotating bodies such as the conveyance roller pairs 30 and 31 that convey the medium P in the conveyance direction by rotating, downstream of the first rotating bodies in the conveyance direction of the medium P, in contact with the medium P conveyed by the first rotating bodies. The recording apparatus 1 in the present embodiment includes the first wheel train A serving as a first drive section that drives the first rotating body with the driving force of the motor M1 serving as the first drive source, the second wheel train B serving as a second drive section that drives the second rotating body with the driving force of the motor M2 serving as the second drive source, and the operation section 70 coupled to the first wheel train A and the second wheel train B, the user being capable of manually operating the first rotating body and the second rotating body with the operation section 70.

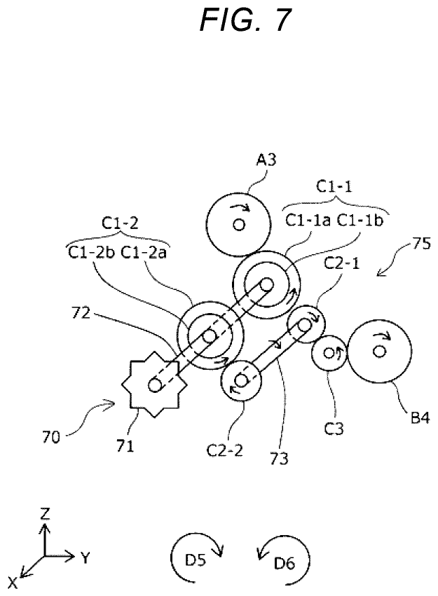

Here, driving of the first wheel train A, the second wheel train B, and the third wheel train C involved in the operation of the operation section 70 is explained with reference to FIGS. 7 to 9. FIG. 7 illustrates a movement of the wheel trains at the time when the recording apparatus 1 conveys the medium P in the conveyance direction at a recording time or the like. At this time, the gear A3 that shares the rotating shaft with the driving roller of the conveyance roller pair 21 rotates in the rotation direction D5 with the driving force of the motor M1. The gear B4 that shares the rotating shaft with the driving roller of the conveyance roller pair 31 rotates in the rotation direction D5 with the driving force of the motor M2. According to the rotation of the gear A3 in the rotation direction D5, the outer section C 1-1a of the gear C 1-1 rotates in the rotation direction D6. However, as explained above, the gear C 1-1 is a one-way clutch and, even if the outer section C 1-1a rotates in the rotation direction D6, the inner section C 1-1b does not rotate together and the outer section C 1-1a idles.

According to the rotation of the gear B4 in the rotation direction D5, the gear C3 rotates in the rotation direction D6. According to the rotation of the gear C3 in the rotation direction D6, the gear C 2-1 rotates in the rotation direction D5. According to the rotation of the gear C 2-1 in the rotation direction D5, the shaft section 73 and the gear C 2-2 also rotate in the rotation direction D5. For this reason, according to the rotation of the gear C 2-2 in the rotation direction D5, the outer section C 1-2a of the rotary gear C 1-2 rotates in the rotation direction D6. However, as explained above, the gear C 1-1 is a one-way clutch and, even if the outer section C 1-1a rotates in the rotation direction D6, the inner section C 1-1b does not rotate together and the outer section C 1-1a idles. As explained above, the recording apparatus 1 according to the present embodiment is configured such that the input section 71 and the shaft section 72 of the operation section 70 do not rotate even when the motor M1 and the motor M2 are driven in order to convey the medium P.

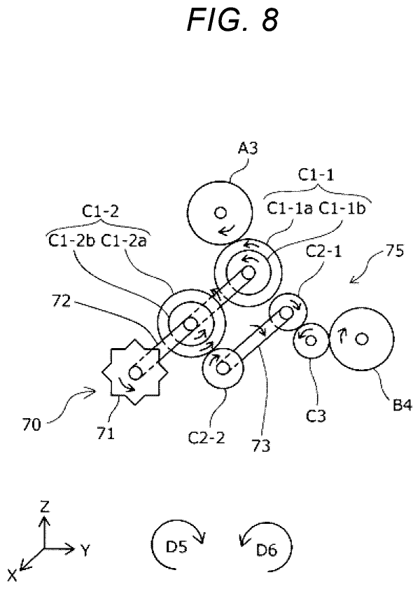

FIG. 8 illustrates the movement of the wheel trains at the time when the user rotates the input section 71 in the rotation direction D6, for example, when a jam occurs. When the user rotates the input section 71 in the rotation direction D6, the shaft section 72 also rotates in the rotation direction D6 and the inner section C 1-1b of the gear C 1-1 and the inner section C 1-2b of the gear C 1-2 also rotate in the rotation direction D6. Then, the outer section C 1-1a also rotates together in the rotation direction D6 according to the rotation of the inner section C 1-1b and the outer section C 1-2a also rotates together in the rotation direction D6 according to the rotation of the inner section C 1-2b. When the outer section C 1-1a rotates in the rotation direction D6, the gear A3, that is, the driving roller of the conveyance roller pair 21 also rotates in the rotation direction D5. Further, the gears A1 and A7, that is, the driving rollers of the conveyance roller pairs 20 and 22 also rotate in the rotation direction D5 via the first wheel train A. When the input section 71 is rotated, the driving rollers of the conveyance roller pairs 20 and 22 do not have to be rotated.

When the outer section C 1-2a rotates in the rotation direction D6, the gear C 2-2 rotates in the rotation direction D5 and, according to the rotation, the shaft section 73 and the gear C 2-1 also rotate in the rotation direction D5. Then, the gear C3 rotates in the rotation direction D6 according to the rotation of the gear C 2-1 in the rotation direction D5 and, according to the rotation, the gear B4, that is, the driving roller of the conveyance roller pair 31 rotates in the rotation direction D5. The rotation of the driving rollers of the conveyance roller pairs 20, 21, and 22 in the rotation direction D5 and the rotation of the driving roller of the conveyance roller pair 31 in the rotation direction D5 correspond to rotation at the time of conveyance of the medium P downstream in the conveyance direction.

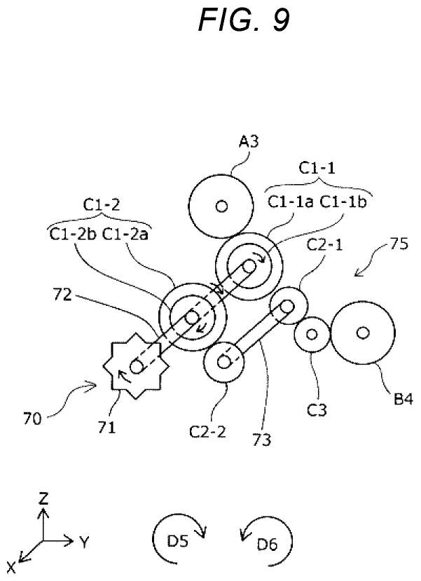

FIG. 9 illustrates the movement of the wheel trains at the time when the user rotates the input section 71 in the rotation direction D5. When the user rotates the input section 71 in the rotation direction D5, the shaft section 72 also rotates in the rotation direction D5 and the inner section C 1-1b of the gear C 1-1 and the inner section C 1-2b of the gear C 1-2 also rotate in the rotation direction D5. However, the outer section C 1-1a does not rotate together in the rotation direction D5 according to the rotation of the inner section C 1-1b and the outer section C 1-2a does not rotate together in the rotation direction D5 according to the rotation of the inner section C 1-2b. That is, even if the user rotates the input section 71 in the rotation direction D5, the input section 71, the shaft section 72, the inner section C 1-1b, and the inner section C 1-2b only idle.

From another viewpoint, the operation section 70 includes the input section 71 to which the user can manually input the operation force and the switching section 75 capable of switching a transmission state in which drive is transmitted between the input section 71 and the first wheel train A and the second wheel train B and a disconnected state in which the drive is not transmitted between the input section 71 and the first wheel train A and the second wheel train B. The switching section 75 includes the gear C 1-1 coupled to the gear A3 and the gear C 1-2 coupled to the gear B4 via the gear C 2-2, the shaft section 73, the gear C 2-1, and the gear C3. That is, the switching section 75 can be regarded as including a first switching section coupled to the first wheel train A and a second switching section coupled to the second wheel train B. The switching section 75 can take the disconnected state when the driving force is input from at least one of the motor M1 and the motor M2 as illustrated in FIG. 7 and can take the transmission state when the driving force is not input from the motor M1 and the motor M2 and the operation force is input to the input section 71 as illustrated in FIG. 8.

As in the recording apparatus 1 in the present embodiment, in the configuration in which the plurality of rotating bodies, that is, the first rotating bodies such as the conveyance roller pairs 20, 21, and 22 and the second rotating bodies such as the conveyance roller pairs 30 and 31 are driven by the different drive sources, that is, the motor M1 and the motor M2, by providing the operation section 70 coupled to the drive sections of both of the first wheel train A and the second wheel train B, it is possible to rotate both the rotating bodies, that is, the first rotating bodies and the second rotating bodies in association with each other with the input of the operation force to one operation section 70. On the other hand, when at least one drive source of the motor M1 and the motor M2 is driven, by taking the disconnected state, it is possible to prevent a load involved in coupling of the operation section 70 to the drive section from occurring.

Further, for example, when there is a rotating body other than the first rotating bodies and the second rotating bodies, it is possible to prevent the rotating body from being affected by a load involved in the coupling of the operation section 70 to the drive section. That is, since it is possible to easily move the medium P to a desired position without applying an excessive load to the medium P, for example, it is possible to easily remove the medium P stopped across the rotating bodies of the different drive sources. Note that there is no particular limitation on where in the drive sections such as the first wheel train A and the second wheel train B the operation section 70 is coupled, and the operation section 70 may be coupled to a place different from the place in the present embodiment.

The first rotating bodies such as the conveyance roller pairs 20, 21, and 22 and the second rotating bodies such as the conveyance roller pairs 30 and 31 convey the medium P downstream in the conveyance direction by rotating in the rotation direction D5 serving as a first rotation direction. As explained above, the first rotating bodies and the second rotating bodies are configured to be rotatable only in the first rotation direction when the operation force is input to the input section 71. As explained above, by limiting the moving direction of the medium P at the time when the operation force is input to the input section 71, it is possible to prevent the medium P from moving in an unintended direction such as the upstream side in the conveyance direction. In the present embodiment, the moving direction of the medium P at the time when the operation force is input to the input section 71 is set to downstream in the conveyance direction to prevent the medium P from moving to the upstream side but the moving direction is not limited to this. That is, in a configuration in which the remove of the medium P is easily if the medium P is moved upstream in the conveyance direction, the moving direction of the medium P at the time when the operation force is input to the input section 71 may be set to upstream in the conveyance direction to prevent the medium P from moving to the downstream side.

As explained above, the first switching section and the second switching section are one-way clutches. In other words, the gear C 1-1 and the gear C 1-2 configuring the first switching section and the second switching section have a function of a one-way clutch. With the configuration explained above, the configuration of the switching section 75 can be simplified.

In addition, in the recording apparatus 1 in the present embodiment, the gear C 1-1 and the gear C 1-2 configuring the first switching section and the second switching section are provided coaxially with the input section 71. With the configuration explained above, it is possible to reduce a space occupied by the first switching section and the second switching section and the like on the inside of the medium conveyance device.

Specifically, the operation section 70 includes the shaft section 72 that rotates integrally with the input section 71. Here, the outer section C 1-1a of the gear C 1-1 meshes with the gear A3 configuring the first wheel train A and the outer section C 1-2a of the gear C 1-2 meshes with the gear B4 configuring the second wheel train B via the gear C 2-2, the shaft section 73, the gear C 2-1, and the gear C3. For this reason, the outer section C 1-1a of the gear C 1-1 can be regarded as being provided in the first wheel train A and the outer section C 1-2a of the gear C 1-2 can be regarded as being provided in the second wheel train B.

When the outer section C 1-1a of the gear C 1-1 is regarded as being provided in the first wheel train A and the outer section C 1-2a of the gear C 1-2 is regarded as being provided in the second wheel train B, the first wheel train A can be expressed as including the outer section C 1-1a serving as a first gear rotating centering on the shaft section 72 and the second wheel train B can be expressed as including the outer section C 1-2a serving as a second gear rotating centering on the shaft section 72. The gear C 1-1 serving as the first switching section can be expressed as being a one-way clutch that switches the transmission state and the disconnected state between the shaft section 72 and the outer section C 1-1a serving as the first gear and the gear C 1-2 serving as the second switching section can be expressed as a one-way clutch that switches the transmission state and the disconnected state between the shaft section 72 and the outer section C 1-2a serving as the second gear. With the configuration explained above, the recording apparatus 1 in the present embodiment can reduce a space occupied by the first switching section and the second switching section and the like on the inside of the medium conveyance device and can implement a simple configuration of these sections.

Here, in the recording apparatus 1 in the present embodiment, a gear ratio of the outer section C 1-1a serving as the first gear and the conveyance roller pair 21 serving as the first rotating body is equal to a gear ratio of the outer section C 1-2a serving as the second gear and the conveyance roller pair 31 serving as the second rotating body. With the configuration explained above, by making the gear ratios uniform and rotating the first gear and the second gear at uniform speed, the recording apparatus 1 in the present embodiment can prevent bending from occurring in the medium P and prevent rubbing from occurring between the medium P and the rotating body.

In other words, in the recording apparatus 1 in the present embodiment, the conveyance roller pair 21 serving as the first rotating body and the conveyance roller pair 31 serving as the second rotating body rotate at the same speed in the state illustrated in FIG. 8 in which the switching section 75 is in the transmission state. With the configuration explained above, the recording apparatus 1 in the present embodiment can prevent bending from occurring in the medium P and prevent rubbing from occurring between the medium P and the rotating body. Accordingly, a method of rotating the conveyance roller pair 21 serving as the first rotating body and the conveyance roller pair 31 serving as the second rotating body at the uniform speed is not limited to the configuration of making the gear ratios uniform explained above.

The recording apparatus 1 in the present embodiment further includes the housing 53 capable of housing the first rotating bodies such as the conveyance roller pairs 20, 21, and 22, the second rotating bodies such as the conveyance roller pairs 30 and 31, the first wheel train A serving as the first drive section, the second wheel train B serving as the second drive section, and the operation section 70. In the recording apparatus 1 in the present embodiment, the conveyance roller pairs 30 and 31, which are the second rotating bodies, are the discharge rollers that discharge the medium P from the housing 53. With the configuration explained above, by driving the discharge roller separately from the first rotating body, the recording apparatus 1 in the present embodiment can achieve both of improvement in productivity and improvement in alignment of the discharged medium P. On the other hand, there is a concern that a problem occurs when the medium P stopped across the first rotating bodies such as the conveyance roller pairs 20, 21, and 22 and the second rotating bodies such as the conveyance roller pairs 30 and 31 is removed. However, the medium P can be easily removed as explained above.

A discharge destination of the medium P may be any component such as another device such as a stacker provided on the inside of the housing 53, a stacker provided on a side surface of the housing 53, a finisher that performs post-processing on the medium P on which the recording has been performed, or a relay unit. The discharge speed of the medium P is not particularly limited and may be higher or lower than the conveyance speed in the medium conveyance path.

The recording apparatus 1 in the present embodiment includes the protrusion unit 100 including the first rotating bodies such as the conveyance roller pairs 20, 21, and 22, the second rotating bodies such as the conveyance roller pairs 30 and 31, the first wheel train A serving as the first drive section, the second wheel train B serving as the second drive section, and the operation section 70. The recording apparatus 1 includes the housing 53 capable of housing the protrusion unit 100 on the inside and is configured to be capable of displacing the protrusion unit 100 to a housed state in which the protrusion unit 100 is housed in the housing 53 and a protruding state in which the protrusion unit 100 protrudes from the housing 53. The input section 71 is configured to be exposed from the housing 53 when the protrusion unit 100 serving as a displacement section is in the protruding state.

Although it is likely that a jam of the conveyed medium P occurs in various places in the medium conveyance path, since the recording apparatus 1 in the present embodiment has the configuration explained above, it is possible to expose the operation section 70 to the outside of the housing 53 in the protruding state in which the protrusion unit 100 protrudes from the housing 53 and it is possible to facilitate, for example, removal of the jammed medium P. The displacement of the protrusion unit 100 between the housed state and the protruding state may be automatically performed or may be manually performed by the user.

As explained above, the recording apparatus 1 in the present embodiment includes the control section 9, and the control section 9 can control, for example, the motor M2 serving as the second drive source. The recording apparatus 1 in the present embodiment further includes a receiving section 9A (see FIG. 1) that includes a not-illustrated operation panel, can be coupled to an external device such as an external computer, and can receive designation of the driving force of the motor M2 from the operation panel, the external device, or the like. With the configuration explained above, the recording apparatus 1 in the present embodiment can designate the driving force of the second drive source, that is, the speed of the second rotating body, and can improve usability. The designation of the speed of the second rotating body may be received on the driving force basis, may be received on the rotation speed basis, or may be received in a form of selecting from candidates in several stages.

Here, the receiving section 9A is capable of receiving an instruction to reset the designation of the driving force of the motor M2, which is the second drive source. With the configuration explained above, it is possible to reset the driving force of the second drive source, that is, the speed of the second rotating body and it is possible to improve usability. Such an instruction can also be received from the not-illustrated operation panel, the not-illustrated external device, or the like. A reset method may reset the driving force of the second drive source, that is, the speed of the second rotating body to initial values or may reset the driving force of the second drive source, that is, the speed of the second rotating body to predetermined set values for resetting.

The recording apparatus 1 in the present embodiment can be expressed as the medium conveyance device including the medium conveyance path explained above and the recording head 8 serving as the recording section that performs recording on the medium P conveyed by the medium conveyance device. Here, the recording apparatus 1 includes, as the medium conveyance device, the feeding path (the cassette feeding track S1, the additional cassette feeding track S2, and the manual feeding path S3) for feeding the medium P to the recording head 8, the reversing path R3 for reversing the front and the back of the medium P on which the recording has been performed by the recording head 8 and causing the medium P to merge with the feeding path, and a first discharge path (the face-up discharge track T1 and the finisher discharge track T3) for discharging the medium P on which the recording has been performed by the recording head 8. Then, the motor M1 serving as the first drive source drives reversing path rotating bodies such as the conveyance roller pairs 27, 28, and 29 located in the reversing path R3. The conveyance roller pairs 30 and 31 serving as the second rotating bodies are located in the first discharge path.

With the configuration explained above, the recording apparatus 1 in the present embodiment can perform recording on the medium P conveyed by the medium conveyance device capable of easily removing the medium P stopped across the rotating bodies of the different drive sources. In the recording apparatus 1 in the present embodiment, the first discharge path is equivalent to the face-up discharge track T1 and the finisher discharge track T3. However, the first discharge path may be configured to be equivalent to the face-down discharge track T2. All of the conveyance roller pairs of the reversing path R3 may configured not to be driven by the first drive source or only a part of the conveyance roller pairs of the reversing path R3 may be configured to be driven by the first drive source.

In the recording apparatus 1 in the present embodiment, the face-up discharge track T1 and the finisher discharge track T3 serving as the first discharge path are the discharge paths for discharging, without curving, the medium P on which the recording has been performed by the recording head 8. Here, the medium conveyance device, which is the recording apparatus 1 in the present embodiment, further includes the face-down discharge track T2 serving as the second discharge path that branches from the first discharge path and curves and discharges the medium P on which the recording has been performed by the recording head 8. The conveyance roller pair 21 serving as the first rotating body and the conveyance roller pairs 30 and 31 serving as the second rotating bodies are located in the first discharge path. The motor M1 serving as the first drive source drives the conveyance roller pairs 22, 23, and 24 and the discharge roller pair 25, which are second discharge path rotating bodies located in the face-down discharge track T2 serving as the second discharge path.

As explained above, the recording apparatus 1 in the present embodiment includes the second discharge path in addition to the first discharge path. The recording apparatus 1 in the present embodiment is configured to be capable of easily removing the medium P stopped across the rotating bodies of the different drive sources not only in the first discharge path but also in the second discharge path. Since the first rotating body only has to be located somewhere in the path of the face-down discharge track T2, the discharge roller pair 25, which is the final roller of the face-down discharge track T2, may be drive separately from the driving of the motor M1 serving as the first drive source.

The present disclosure is not limited to the embodiment and the modifications explained above. Various modifications are possible within the scope of the disclosure set forth in the appended claims. It is obvious that the modifications are also included within the scope of the present disclosure.

What is claimed is:

1. A medium conveyance device comprising:
a first rotating body configured to convey a medium in a conveyance direction by rotating in contact with the medium;
a second rotating body configured to, downstream of the first rotating body in the conveyance direction, convey the medium in the conveyance direction by rotating in contact with the medium conveyed by the first rotating body;
a first drive section configured to drive the first rotating body with a driving force of a first drive source;
a second drive section configured to drive the second rotating body with a driving force of a second drive source; and
an operation section coupled to the first drive section and the second drive section, the first rotating body and the second rotating body being able to be manually operated with the operation section, wherein
the operation section includes:
an input section to which an operation force can be manually input; and
a switching section configured to switch a transmission state in which drive is transmitted between the input section and the first and the second drive sections and a disconnected state in which the drive is not transmitted between the input section and the first and the second drive sections,
the switching section includes a first switching section coupled to the first drive section and a second switching section coupled to the second drive section, and
the switching section takes the disconnected state when the driving force is input from the first drive source or the second drive source and takes the transmission state when the driving force is not input from the first drive source or the second drive source and an operation force is input to the input section.

2. The medium conveyance device according to claim 1, wherein the first rotating body and the second rotating body convey the medium downstream in the conveyance direction by rotating in a first rotation direction and is configured to be rotatable only in the first rotation direction when the operation force is input to the input section.

3. The medium conveyance device according to claim 2, wherein the first switching section and the second switching section respectively include one-way clutches.

4. The medium conveyance device according to claim 1, wherein the first switching section and the second switching section are provided coaxially with the input section.

5. The medium conveyance device according to claim 4, wherein
the operation section includes a shaft section configured to rotate integrally with the input section,
the first switching section includes:
a first gear coupled to the first drive section and configured to rotate centering on the shaft section; and
a one-way clutch configured to switch the transmission state and the disconnected state between the shaft section and the first gear, and
the second switching section includes:
a second gear coupled to the second drive section and configured to rotate centering on the shaft section; and
a one-way clutch configured to switch the transmission state and the disconnected state between the shaft section and the second gear.

6. The medium conveyance device according to claim 5, wherein a gear ratio of the first gear and the first rotating body is equal to a gear ratio of the second gear and the second rotating body.

7. The medium conveyance device according to claim 1, wherein the first rotating body and the second rotating body rotates at same speed when the switching section is in the transmission state.

8. The medium conveyance device according to claim 1, further comprising a housing capable of housing the first rotating body, the second rotating body, the first drive section, the second drive section, and the operation section, and
the second rotating body is a discharge roller configured to discharge the medium from the housing.

9. The medium conveyance device according to claim 1, further comprising:
a housing capable of housing the first rotating body, the second rotating body, the first drive section, the second drive section, and the operation section; and
a displacement section capable of displacing to a housed state in which the first rotating body, the second rotating body, the first drive section, the second drive section, and the operation section are housed in the housing and a protruding state in which the first rotating body, the second rotating body, the first drive section, the second drive section, and the operation section protrude from the housing, and
the input section is exposed from the housing in the protruding state.

10. The medium conveyance device according to claim 1, further comprising:
a control section configured to control the second drive source; and
a receiving section configured to receive designation of a driving force of the second drive source.

11. The medium conveyance device according to claim 10, wherein the receiving section is capable of receiving an instruction to reset the designation of the driving force of the second drive source.

12. A recording apparatus comprising:
the medium conveyance device according to claim 1; and
a recording section configured to perform recording on the medium conveyed by the medium conveyance device, wherein
the medium conveyance device includes:
a feeding path configured to feed the medium to the recording section;
a reversing path configured to reverse a front and a back of the medium on which the recording was performed by the recording section and cause the medium to merge with the feeding path; and
a first discharge path configured to discharge the medium on which the recording was performed by the recording section,
the first drive source drives a reversing path rotating body located in the reversing path, and
the second rotating body is located in the first discharge path.

13. The recording apparatus according to claim 12, wherein
the first discharge path is a discharge path configured to discharge, without curving, the medium on which the recording was performed by the recording section,
the medium conveyance device further includes a second discharge path configured to branch from the first discharge path and curve and discharge the medium on which the recording was performed by the recording section,
the first rotating body and the second rotating body are located in the first discharge path, and
the first drive source drives a second discharge path rotating body located in the second discharge path.
